(19) United States
(12) Patent Application Publication
(10) Pub. No.: US 2013/0167192 A1
(43) Pub. Date: Jun. 27, 2013

(54) METHOD AND SYSTEM FOR DATA PATTERN MATCHING, MASKING AND REMOVAL OF SENSITIVE DATA

(71) Applicant: WELLPOINT, INC., Chicago, IL (US)

(72) Inventors: Sean J. Hickman, Glastonbury, CT (US); Youyi Mao, Woodbridge, CT (US)

(73) Assignee: WELLPOINT, INC., Chicago, IL (US)

(21) Appl. No.: 13/723,858

(22) Filed: Dec. 21, 2012

Related U.S. Application Data
(60) Provisional application No. 61/580,480, filed on Dec. 27, 2011.

(51) Int. Cl. G06F 21/60

(52) U.S. Cl. CPC G06F 21/60
USPC 726/1

(57) ABSTRACT

Systems, methods and computer-readable media for applying policy enforcement rules to sensitive data. An unstructured data repository for storing unstructured data is maintained. A structured data repository for storing structured data is maintained. Request for information is received. The request is analyzed to determine its context. Based on the context, a policy enforcement action associated with generating a response to the request is identified. The policy enforcement action may be to remove sensitive data in generating the response to the request and/or mask sensitive data in generating a response to the request. An initial response to the request is generated by retrieving unstructured data from the unstructured data repository. Using the structured data maintained in the structured data repository, sensitive data included within the initial response is identified. The policy enforcement action is applied to the sensitive data included within the initial response to generate the response to the request.

### CROSS REFERENCE TO RELATED APPLICATIONS

This application claims priority to U.S. Provisional Patent Application No. 61/580,480, filed Dec. 27, 2011, the entirety of which is incorporated herein by reference.

### FIELD OF THE INVENTION

The systems and methods described herein relate to identifying and masking or removing sensitive data contained in communications.

### SUMMARY OF EMBODIMENTS OF THE INVENTION

The present invention is directed to systems, methods and computer-readable media for applying policy enforcement rules to sensitive data. An unstructured data repository for storing unstructured data is maintained. A structured data repository for storing structured data is maintained. A request for information is received. The request is analyzed to determine its context. Based on the context, a policy enforcement action associated with generating a response to the request is identified. The policy enforcement action may be to remove sensitive data in generating the response to the request and/or to mask sensitive data in generating a response to the request. An initial response to the request is generated by retrieving unstructured data from the unstructured data repository. Using the structured data maintained in the structured data repository, sensitive data included within the initial response is identified. The policy enforcement action is applied to the sensitive data included within the initial response to generate the response to the request.

### BRIEF DESCRIPTION OF THE DRAWINGS

FIG. 1 is a flow diagram illustrating an exemplary method of the present invention;

FIG. 2 is a diagram illustrating an exemplary method of the present invention;

FIG. 3 is a diagram illustrating an exemplary system and method of the present invention;

FIG. 4 is a diagram illustrating an exemplary system and method of the present invention;

FIG. 5 is a diagram illustrating an exemplary method of the present invention;

FIGS. 6A and 6B are diagrams illustrating an exemplary system of the present invention; and

FIG. 7 is a diagram illustrating an exemplary system of the present invention.

### DETAILED DESCRIPTION

Clinical data masking and removal is a method for desensitizing raw, unstructured (e.g., free from) data. The desensitization process masks or removes specific data values whose presence will lead to violation of sensitive data protection regulations. These regulations could be defined internally as part of an organization's data management policies or these regulations can be defined by governmental departments and agencies. Desensitized, unstructured data is essential for many different applications, including training of machine learning components.

Embodiments of the systems and methods described herein are designed to be independent of the source systems and are able to apply clinical processing rules and pattern matching and extraction across various kinds of raw clinical data. Certain embodiments may also allow for keeping track of previous pattern search results and human actions on it, to further learn to better apply the patterns and extract data that is more meaningful to the user into the future. Other embodiments may allow for introduction of new patterns as further needs arise with little to no changes in existing information processing rules. Still other embodiments may further allow for human intervention and oversight around the matching and masking decisions and continue to learn from it.

With regard to data pattern matching tools and algorithms, some existing pattern matching tools are able to detect specific patterns within raw unstructured (free form) data. Such pattern matching tools can be effective in finding commonly identified data. However, existing pattern matching tools are not customized to detect uncommon data patterns (e.g., uncommon human names). Thus, the use of data pattern matching tools for desensitization of clinical data has been proven to be imperfect. Subsequently, additional desensitization of specific data attributes and data values is necessary. For example, data pattern matching tool cannot differentiate between Nov. 10, 1964 (date of birth) and Dec. 25, 2011 (Christmas 2011). This creates a situation where a sensitive data policy that regulates the use of date of birth information is difficult to implement with a data pattern matching tool, as both the data of birth and Christmas 2011 dates are likely to be incorrectly detected as sensitive data by the pattern matching tool.

The solution described herein targets to implement efficient algorithms around data pattern matching and eventual masking and/or removal of sensitive information.

The approach to sensitive data management as detailed herein brings together the ability to include specific context in the form of structured data (e.g., Member Personal Health Information) and uses the structured data as a source for detecting sensitive data (e.g., PHI data) within unstructured data (e.g., Clinical RN notes).

Certain intelligent computer systems need large amounts of training data to achieve designed accuracy. Such systems are not designed and deployed to secure PHI. Certain embodiments of methodologies described herein scramble the PHI from unstructured data sources to generate the training data. For example, PHI information may be stored in two kinds of formats: structured formats (such as database table fields dedicated to particular type of information such as DOB, member id, names, SSN etc.) and unstructured formats (such phone conversation logs, fax and nurse notes etc.). By utilizing the structured PHI information to identify the PHI information in unstructured data, a greater accuracy can be achieved.

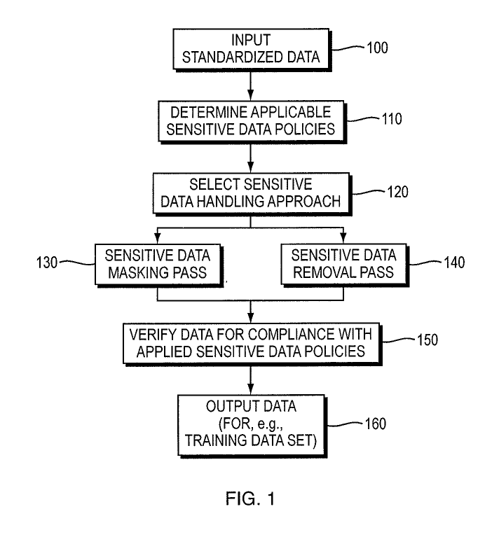

FIG. 1 is a diagram illustrating exemplary steps that may be involved in a process for desensitization of data. In step 100, data (free form, but may be standardized in accordance with a data model) is input to the system. In step 110, applicable sensitive data policies are determined. In step 120, a sensitive data handling approach is selected. In step 130, the data is reviewed for sensitive data that is to be masked and, in step 140, the data is reviewed for sensitive data that is to be removed. In step 150, data is verified for compliance with applied sensitive data policies. In step 160, the processed data is output and can be used, for example, for training data.

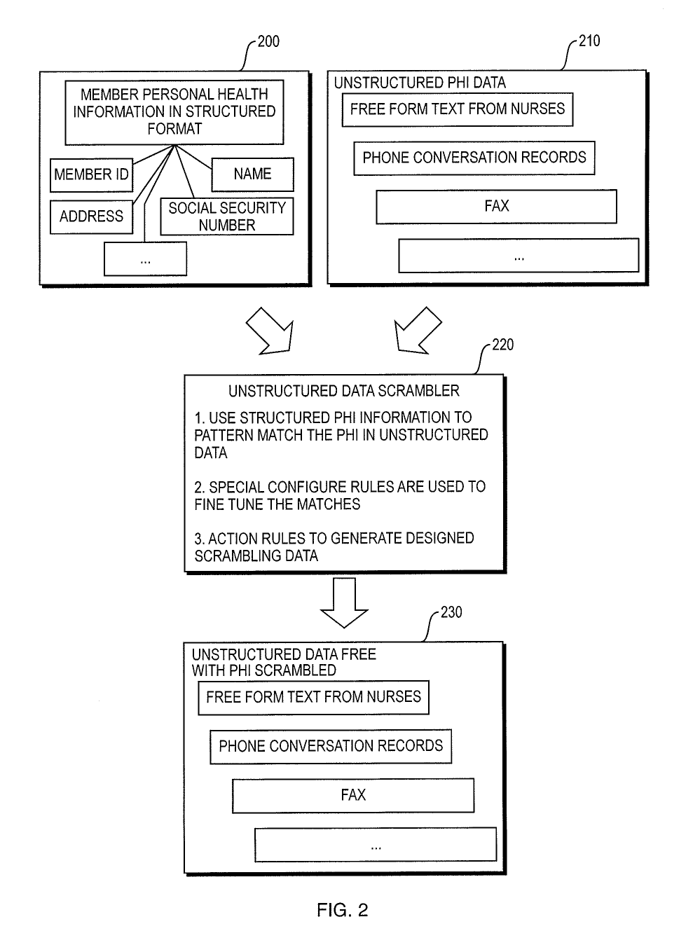

FIG. 2 is a diagram illustrating an example of how the methodology can be used in connection with processing clinical data in the healthcare context. In particular, FIG. 2 illustrates a methodology for using specific structured information/data as an anchor for detecting patterns in unstructured information/data. Structured member PHI data 200 is maintained by a healthcare entity (e.g., a payor) and which may include member ID, name, address, social security information and other structured data. A clinical data model may be used to transform clinical data from heterogeneous data sources into a standardized clinical data format. Unstructured PHI data 210 is received or maintained, which may include, for example, free form text from nurses' notes, phone conversation records, faxes and other forms of unstructured data. Software module 220 receives the member PHI data 200 and the unstructured PHI data 210. Software module 220 uses the structured member PHI data 200 to pattern match the unstructured PHI data 210. In particular, software module 220 employs a methodology that can be customized and extended to apply various internal and external sensitive data policies and regulations. Configuration rules are used to fine tune the matches. Action rules are used to generate designed scrambling data. The output of the software module 220 is the unstructured PHI data with sensitive data removed 230. Training data may be created from desensitized clinical data. This training data can be used by machine learning systems to improve accuracy and quality of outcomes from machine learning based systems.

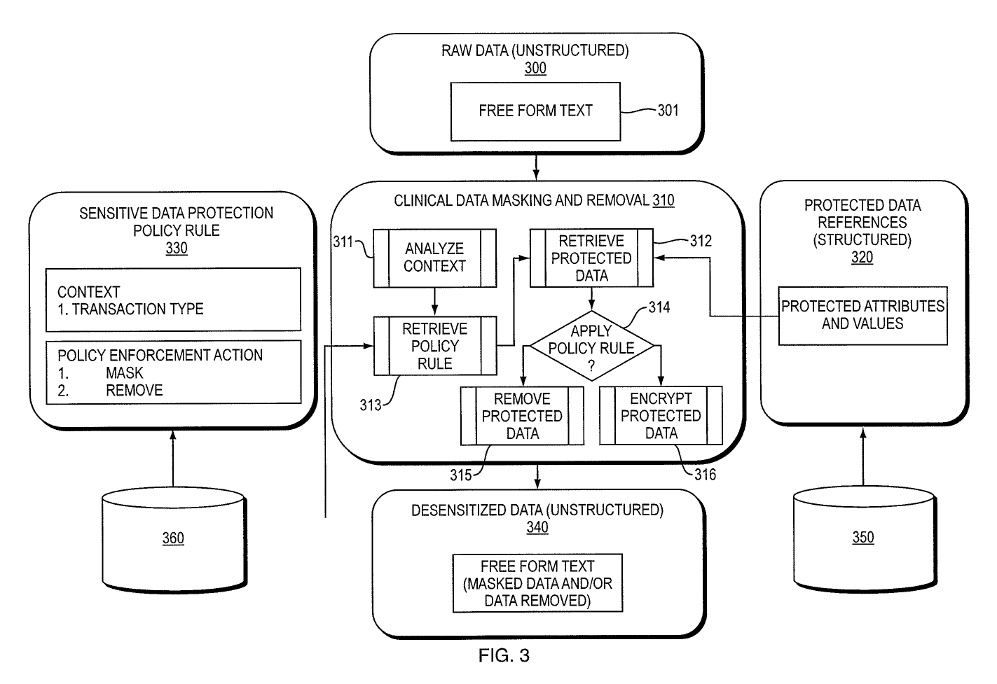

FIG. 3 is a diagram further illustrating a method and system for desensitizing clinical data. Raw data (unstructured, free-form text) 300 is received at the clinical data masking and removal engine 310 (i.e., a specially programmed processor). Clinical data masking and removal engine 310 carries out several steps of the methodology, in one exemplary embodiment. In step 311, engine 310 analyzes the context of the request for information. Once it determines context, in step 313, it retrieves the policy rule applicable to the context. Such information may be obtained from policy rule repository 360. For example, rule data 330 contained in the repository may inform that, for a given context (e.g., transaction type), the policy enforcement action is to either mask or remove the sensitive data. Referring back to engine 310, in step 312, the protected data is retrieved from repository 350. Repository 350 may, for example, provide a single source of truth for all information regarding members. Repository 350 includes structured data 320 that describes protected data (i.e., protected attributes and values). Engine 310 uses the structured data 320 to identify the data elements that are to be protected in the raw data 300, and, in step 314, applies the rule accordingly (e.g., remove protected data in step 313 or mask protected data in step 316). Engine 310 then outputs the desensitized, unstructured data 340 (e.g., free form text with data masked or removed).

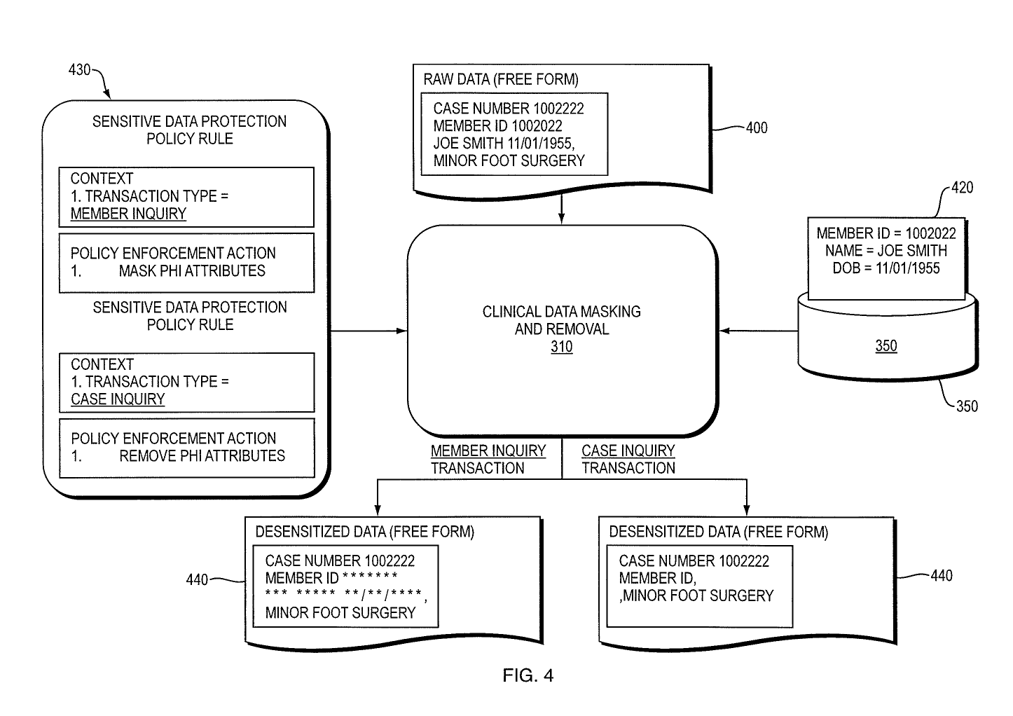

A specific example is now illustrated with reference to FIG. 4. In particular, the example illustrated in FIG. 4 shows how raw clinical data in the form of RN notes captured in utilization management cases can be desensitized based on the type of transaction. There are two types of transactions illustrated—1) Member inquiry and 2) Case inquiry. A member inquiry transaction results in masking of PHI data detected in the RN note. The clinical data masking and removal method uses structured data from existing databases (e.g., member information databases) to detect the specific information (e.g., member ID, member name and date of birth) in the unstructured data. A case inquiry transaction results in the removal of PHI data detected in the RN note. Note in this example that the case number and member ID are of the same data type (numbers) and the same length (7 digits). Despite the similarities between the member ID and case number, the clinical data masking and removal method is capable of detecting and desensitizing the member ID without impacting case number.

Referring particularly to FIG. 4, raw (e.g., free form/unstructured) data is received by engine 310. In this example, the data includes a case number, a member ID, a name of the member, a date and the type of procedure for that member. Clinical data masking and removal engine 310 carries out several steps of the methodology, in one exemplary embodiment. As described above with regard to FIG. 3, engine 310 analyzes the context of the request for information. Once it determines the context, it retrieves the policy rule 430 applicable to the context. In this example, for the context in which the transaction type is a member inquiry, the policy enforcement action is to mask PHI attributes. Further, in this example, for the content in which the transaction type is a case inquiry, the policy enforcement action is to remove PHI attributes. Referring back to engine 310, structured data elements 420 (e.g., attributes and values), which are identified to be protected/considered sensitive 420, is retrieved from repository 350. In this example, the structured data elements that are identified as being sensitive are the member ID, the name, and the date of birth. Engine 310 uses the structured data elements 420 to recognize and identify the data elements that are to be protected in the raw data 400 (i.e., in this example, the member ID, the member name, and his date of birth) and applies the rule accordingly. Engine 310 renders outputs 440 of the desensitized, unstructured data 340. In this example, for a member inquiry, the output shows the member ID number, member name, and date of birth masked. For a case inquiry, the output shows the member ID, member name, and date of birth removed.

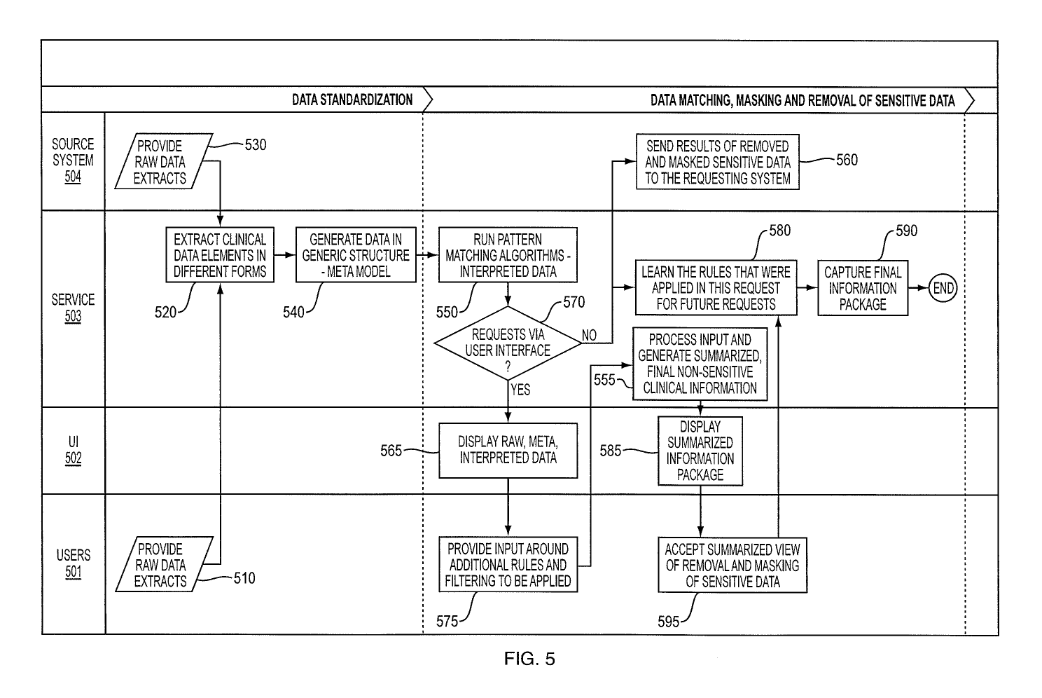

FIG. 5 further illustrates an example of how the systems and methods described herein may be implemented. End users of the system 501 (e.g., free form text 301 of FIG. 3) may provide raw data extracts in step 510. Raw data extracts may also be obtained from source systems in 504 (e.g., raw data 300 of FIG. 3) in step 530. Service 503 (e.g., an application running on engine 310 of FIG. 3) extracts clinical data elements in different forms, in step 520, and generates data in a generic structure according to meta data model in step 540. Service 503 may then run pattern matching algorithms to generate interpreted data in step 550. If a request for information was received from user interface 502, the raw data, meta data and interpreted data is displayed in step 565. In step 575, the user 501 may review the results and provide input regarding additional rules and filtering that may applied. In step 555, the service 503 may process the input and generate summarized, final non-sensitive clinical information. In step 585, the information package is displayed on the user interface 502. In step 595, the user 501 may accept the summarized view of the removal and masking of sensitive data. In step 580, the service 503 may learn the rules that were applied in this request to future requests. In step 590, the final information package is captured. Returning back to step 570, if the data was not requested via a user interface, in step 560, the result of the removed and masked sensitive data is returned to the requesting system 504.

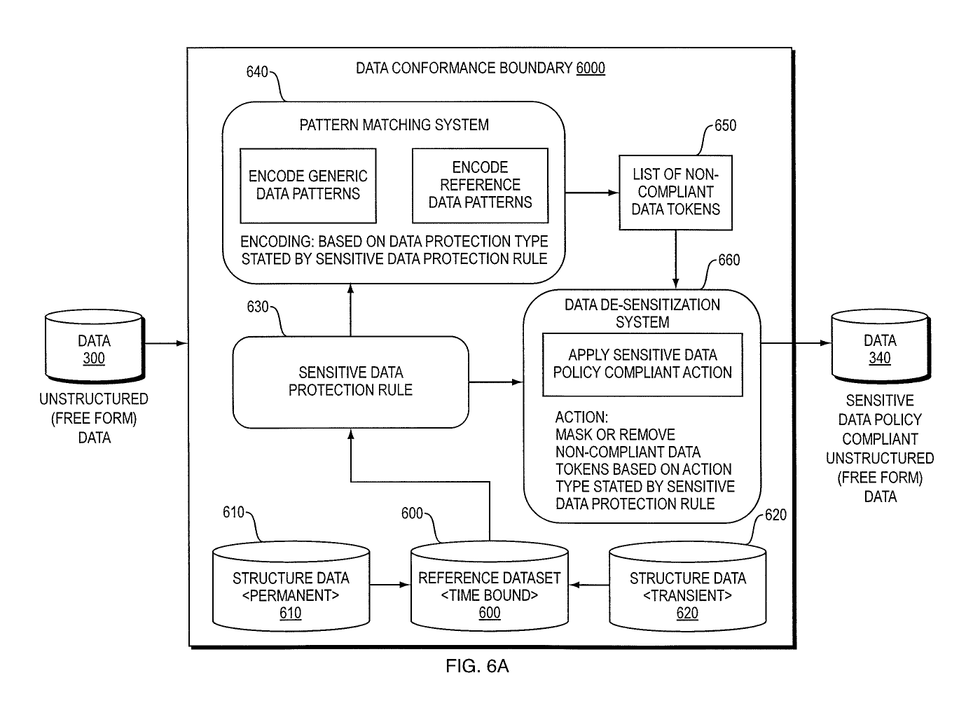

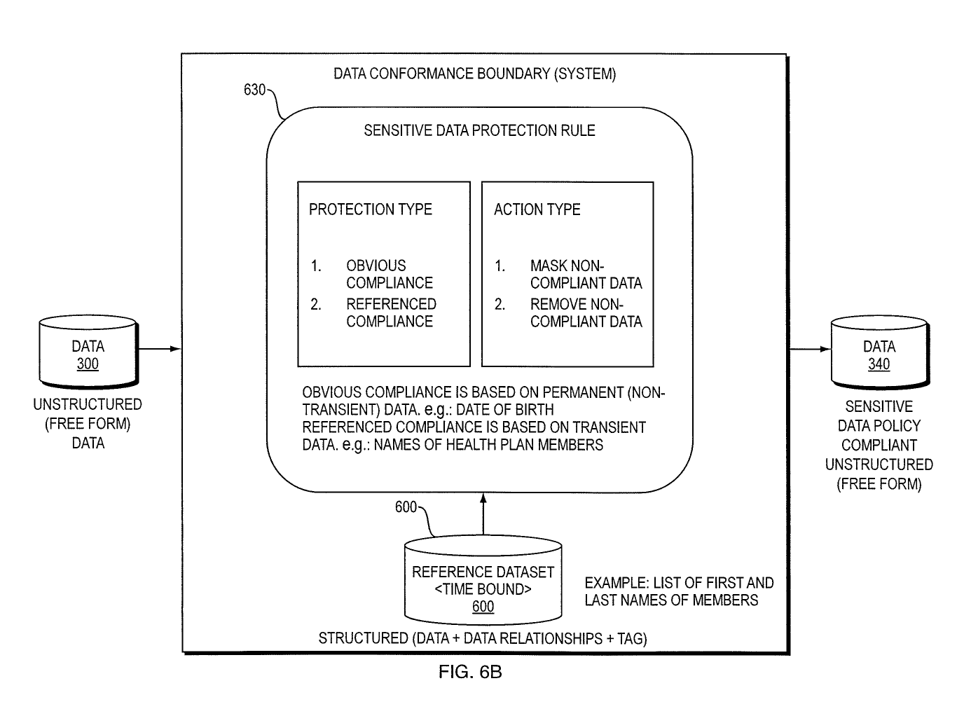

With reference to FIG. 6A, an exemplary system of the present invention is further illustrated. Unstructured (e.g., free form) data is received at system 6000 from repository 300 for processing. A reference dataset repository 600 is built from permanent structured data, maintained in repository 610, and transient structured data, maintained in repository 620. Data from repository 600, along with sensitive data protection rule system 630 (described in more detail with reference to FIG. 6B), is used by the pattern matching engine 640 to identify and compile a list of non-compliant data tokens 650. Pattern matching engine 640 encodes generic data patterns and reference data patterns based on the data protection type as stated by the sensitive data protection rule (i.e., from system 630). Data de-sensitization engine 660 applies sensitive data policy compliant actions (obtained from system 630) to the list of non-compliant data tokens 650. In particular, engine 660 masks or removes non-compliant data tokens based on the action type stated by the sensitive data protection rule. Engine 660 then outputs data 340 (i.e., unstructured data that is sensitive data policy compliant).

Referring now to FIG. 6B, sensitive data protection rule system 630 is described in more detail. Reference dataset repository 600 includes structured data, e.g., includes the data itself, the relationship among the data, and tags identifying the data. Engine 630 applies two types of rules. The first type relates to the type of compliance to be applied. One type of compliance is obvious compliance. Determination of obvious compliance is based on permanent/non-transient reference data (e.g., data of birth, which does not change for a given member). Another type of compliance is reference compliance. Determination of reference compliance is based on transient reference data (e.g., the name of a health plan member, which may change over time). Engine 630 also applies rules to determine what action to take for compliant data (e.g., mask or remove, as described in more detail above with regard to FIGS. 3 and 4).

Thus, structured PHI information is used to pattern match the PHI in unstructured data. This can be accomplished by doing searches (exact, like, or pattern matching) in the unstructured data to ensure the fields in the structured contextual data that need to be removed or redacted are not included in the output unstructured data.

Configured rules may be used to fine tune pattern matching. Each field has different redaction or removal requirements. For example, there may be an age in the output data that needs to be removed, but the structured contextual data has only a data of birth. Subject matter experts may configure rules using the structured data that will accomplish the desired goal in the unstructured data. For example, in the age example, the method may look for the date of birth, month/year, and age to remove not just an exact match on the source structured date of birth. The method would not just pattern match and remove all dates; otherwise, valuable information in the unstructured data would be removed.

Action rules may be used to generate designed scrambling data. One example involves encrypting an identifier used to match the request and response on return. The customer profile key is encrypted so the service provider cannot see it, but the caller can unencrypt it on response to properly match or update source systems.

The clinical data masking and removal system and method may include the ability to detect specific contexts in which to apply specific sensitive data protection policy rules. This capability enables the method to detect semantic differences across syntactic similarities (for example, the case number and member ID being similar in data type and data lengths in the above example of FIG. 4).

The system and method may also include ability to mask (i.e., encrypt) parts of unstructured (i.e., free form) data. Data encryption tools generally encrypt the entire unstructured data. The methods and systems defined herein can selectively encrypting data within unstructured (i.e., free form) text. The selective and granular application of the encryption logic is enabled by the systems and methods described herein.

The systems and methods may also provide the ability to generate desensitized, context sensitive unstructured data that conforms to multiple sensitive data protection policies (e.g., masking or removal).

The clinical data pattern matching masking and removal of sensitive data system and method may include the following characteristics, in some embodiments.

The systems and methods may standardize various data formats into a consistent meta model. Data from each source system may be processed as per business rules and context applicable to that system and is converted into a common model. The common model is agnostic of the source system.

Also, the systems and methods gather the rules that need to be applied. Rules may be categorized as source system rules or data driven rules. Source system rules are rules that need to be executed to understand the data model available within the source system so that meaningful data extraction can occur. Data driven rules are rules that are independent of the source from which the data was extracted, but pertain to understanding the context of the extracted data to generated interpreted sections from free form text.

Pattern matching algorithms may be run to obtain interpreted data. The pattern matching algorithm is primarily associated with the clinical data driven rules. Patterns such as keywords used to describe, e.g., the procedure or diagnosis codes, may be used to detect portions of text that are relevant for clinical purposes. Other examples include use of common vocabulary to determine an outcome. For example, “Approved”, “Pended”, “Referred to Physician” may be used to detect portions of text that refer to the clinical outcome. The common vocabulary used may be an expandable library of keywords and phrases that help to break down free form text into meaningful clinical data. Additional pattern matching algorithms may employed (i.e., general patterns used to extract clinical data from free form text, such as faxes sent by physicians, nurse phone conversations, scripted text data used for data entry, etc.). These patterns are generalized such that relevant clinical data can be extracted. For example, the possible formats of data that may be found in a fax are configured within the system. When the algorithm is executed against the data, each pattern is evaluated and computed for a level of “match-factor”. The higher the match-factor, the higher is the probability for a pattern match.

The systems and methods may also allow for display of identified patterns and suggestions. Data as extracted from the source system by applying source system rules is made available for manual reference or validation. This data may then be represented in the common model. Data obtained by applying clinical data rules/pattern matching algorithms on the common model is available as interpreted data.

The systems and methods may also allow for the removal of clinically sensitive data. Extraction of data from source system focuses on extracting meaningful clinical data and leaves out member-specific information. This is one of the initial steps for excluding sensitive data. Once the common model and interpreted data are generated, another set of cleansing rules can be applied on the entire data set. For example, data may be scanned for member ID numbers, dates of birth, member names, addresses, SSN, phone number, etc. These exclusion rules can be configured within the system so that new patterns can be entered within the system, as applicable, making it more efficient over iterations.

The systems and methods may also capture human feedback around final data abstraction/aggregation to create meaningful information with sensitive clinical data excluded. Data extraction in the common model and interpreted form may be made available to allow for processing of any manual edits to the extract. This serves several purposes. First, manual validation and correction of the extraction may be achieved. Further, additional patterns and rules that are observed during the manual process may be fed back to the extraction process to make it more efficient over iterations.

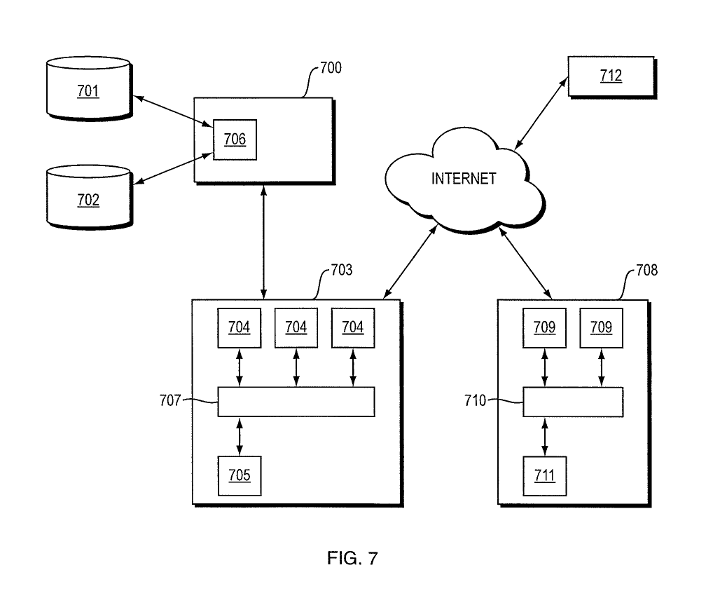

The systems described herein comprise a number of different hardware and software components. Exemplary hardware and software that can be employed in connection with the system are now generally described with reference to FIG. 7. Database server(s) 00 may include a database services management application 706 that manages storage and retrieval of data from the database(s) 701, 702. The databases may be relational databases; however, other data organizational structure may be used without departing from the scope of the present invention. One or more application server(s) 703 are in communication with the database server 700. The application server 703 communicates requests for data to the database server 700. The database server 700 retrieves the requested data. The application server 703 may also send data to the database server for storage in the database(s) 701, 702. The application server 703 comprises one or more processors 704, computer readable storage media 705 that store programs (computer readable instructions) for execution by the processor(s), and an interface 707 between the processor(s) 704 and computer readable storage media 705. The application server 203 may store the computer programs referred to herein.

To the extent data and information is communicated over the Internet, one or more Internet servers 708 may be employed. The Internet server 708 also comprises one or more processors 709, computer readable storage media 711 that store programs (computer readable instructions) for execution by the processor(s) 709, and an interface 710 between the processor(s) 709 and computer readable storage media 711. The Internet server 708 is employed to deliver content that can be accessed through the communications network. When data is requested through an application, such as an Internet browser employed by end user computer 712, the Internet server 708 receives and processes the request. The Internet server 708 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed using a processor.

What is claimed is:

1. A computer implemented method comprising:
maintaining an unstructured data repository for storing unstructured data;
maintaining a structured data repository for storing structured data;
receiving a request for information;
analyzing a context for the request for information using a computer processor;
based on the context, identifying a policy enforcement action associated with generating a response to the request, using a computer processor,
wherein the policy enforcement action comprises one or both of remove sensitive data in generating the response to the request and mask sensitive data in generating a response to the request;
generating an initial response to the request, using a computer processor, by retrieving unstructured data from the unstructured data repository;
using the structured data maintained in the structured data repository, identifying sensitive data included within the initial response, using a computer processor; and
applying the policy enforcement action to the sensitive data included within the initial response to generate the response to the request, using a computer processor.

2. A non-transitory computer readable storage medium having computer-executable instructions recorded thereon that, when executed on a computer, configure the computer to perform a method comprising:
maintaining an unstructured data repository for storing unstructured data;
maintaining a structured data repository for storing structured data;
receiving a request for information;
analyzing a context for the request for information;
based on the context, identifying a policy enforcement action associated with generating a response to the request,
wherein the policy enforcement action comprises one or both of remove sensitive data in generating the response to the request and mask sensitive data in generating a response to the request;
generating an initial response to the request by retrieving unstructured data from the unstructured data repository;
using the structured data maintained in the structured data repository, identifying sensitive data included within the initial response; and
applying the policy enforcement action to the sensitive data included within the initial response to generate the response to the request.

3. A system comprising:
memory operable to store at least one program; and
at least one processor communicatively coupled to the memory, in which the at least one program, when executed by the at least one processor, causes the at least one processor to:
maintain an unstructured data repository for storing unstructured data;
maintain a structured data repository for storing structured data;
receive a request for information;
analyze a context for the request for information;
based on the context, identify a policy enforcement action associated with generating a response to the request,
wherein the policy enforcement action comprises one or both of remove sensitive data in generating the response to the request and mask sensitive data in generating a response to the request;
generate an initial response to the request by retrieving unstructured data from the unstructured data repository;
using the structured data maintained in the structured data repository, identify sensitive data included within the initial response; and
apply the policy enforcement action to the sensitive data included within the initial response to generate the response to the request.
